(19) United States
(12) Patent Application Publication
(10) Pub. No.: US 2010/0299310 A1
(43) Pub. Date: Nov. 25, 2010

(54) METHOD FOR ACCESSING DATA STORAGE UNIT

(75) Inventor: Yu-Liang SUN, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/505,548

(22) Filed: Jul. 20, 2009

(30) Foreign Application Priority Data
May 19, 2009 (TW) 98116604

(51) Int. Cl. G06F 12/16; G06F 12/00

(52) U.S. Cl. 707/640; 711/162; 711/E12.001; 711/E12.103; 711/112; 711/103; 707/812

(57) ABSTRACT

In a method for accessing a data storage unit, an access instruction for the data storage unit is received from a client side, and a step is performed to determine if the data storage unit has been shut down. When the access instruction is issued for browsing the data storage unit which has been shut down, archive information on the storage unit is obtained from a database, and the file directory information is delivered to the client side, so that the client side may browse the data storage unit based on the file directory information.

### RELATED APPLICATIONS

This application claims priority to Taiwan Application Serial Number 98116604, filed May 19, 2009, which is herein incorporated by reference.

### BACKGROUND

1. Field of Invention

The present invention relates to a circuit layout method. More particularly, the present invention relates to a circuit layout method for adding trailing pad symbol.

2. Description of Related Art

Computers have become indispensable tools in modern offices. One office generally has many units of computers, which have become one of the major power consuming items. Further, with the advent of energy-saving and carbon-reducing consciousness, electric power saving has become an important issue for computers.

Generally speaking, shutting down the peripheral devices (such as a screen and a hard disk) of a computer is one of the most popular methods for saving electric power consumed by the computer. For example, after a hard disk of a computer has not been accessed for a period of time, the computer may shut down its hard disk or let its hard disk enter a sleep mode, thereby saving the electric power consumed by the hard disk under waiting mode. Whenever a user desires to access the data in the hard disk that has been shut down, the hard disk is then waked up to allow the user to access the data therein.

However, while accessing a hard disk, the user often merely wants to browse a file or directory list stored in the hard disk, instead of actually executing or retrieving the data in the hard disk. In this situation, if the hard disk which has been shut down is waked up accordingly, electric power will be wasted unnecessarily. Especially, when the aforementioned hard disk is a logic disk composed of many tangible hard disks, the electric power consumed by waking up the shutdown hard disk will be immense. Further, it takes a lot of time to wake up the hard disk which has been shut down, thus causing bothers to users On the other hand, switching the hard disk between the shot-down mode and the awake mode too frequently will increase the probability of damaging the hard disk.

### SUMMARY

Hence, an aspect of the present invention is to provide a method for accessing a data storage unit, thereby obtaining archive information of the data storage unit from a database for browsing the data storage unit. Thus, for browsing the data storage unit, it does not need to wake up the data storage unit which has been shut down.

According to an embodiment, a method for accessing a data storage unit, comprising the following steps receiving an access instruction for the data storage unit from a client side; determining if the access instruction is used for browsing the data storage unit; determining if the data storage unit has been shut down; obtaining archive information of the data storage unit from a database, when the access instruction is used for browsing the data storage unit which has been shut down; and delivering the archive information to the client side, so that the client side may browse the data storage unit based on the archive information.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description appended claims, and accompanying drawings where;

FIG. 1 is a flow chart showing a method for accessing a data storage unit according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

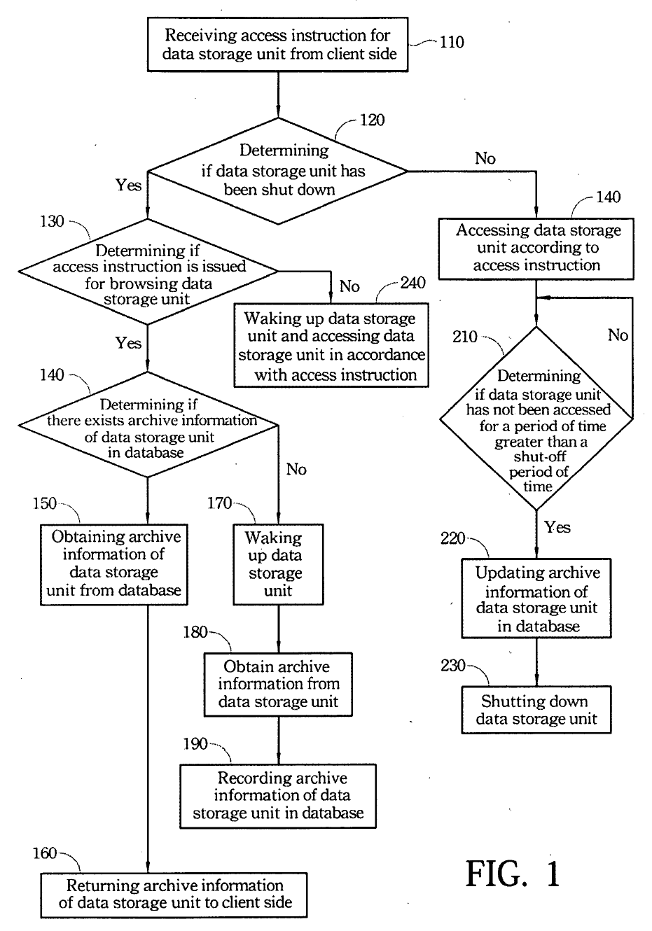

Referring to FIG. 1, FIG. 1 is a flow chart showing a method for accessing a data storage unit according to an embodiment of the present invention. The method is used to obtain archive information of the data storage unit from a database so as to browse he data storage unit. Hence, the method 100 for accessing the data storage unit comprises the following steps.

When an access instruction is received from a client side for accessing a data storage unit (step 110), step 120 is performed to determine if the data storage unit has been shut down, wherein the data storage unit can be a logic disk, a tangible hard disk or a remote storage unit linked to a host side via a network. The logic disk can be composed of a redundant array of independent disk (RAID). The tangible hard disk can be a hard disk drive (HDD), a solid state disk (SDD), a flash disk or a hybrid hard disk or another type of storage unit.

When the data storage unit has been shut down, step 130 is performed to determine if the access instruction is issued for browsing the data storage unit. When the access instruction is not for browsing the data storage unit, step 240 is performed to wake up the data storage unit, and to access the data storage unit in accordance with the access instruction. On the other hand, when the access instruction is issued for browsing the data storage unit, step 150 is performed to obtain archive information of the data storage unit from a database, and step 160 is performed to return the archive information of the data storage unit to the client side, wherein the archive information may comprise an archive list of the data storage unit or other related information (such as size, attribute or type) of the data storage unit, but does not include the files stored in the data storage unit or the files stored in each directory thereof. The database is stored in a memory device not belonging to the data storage unit. For example, the memory device can be a memory such as a random access memory or another type of memory, or a hard disk drive such as a solid state disk, a flash disk, a hybrid hard disk or another type of hard disk. Consequently, by using steps 120 to 160, the client side does not need to first wake up the data storage unit which has been shut down, and can browse the data storage unit in accordance with the archive information thereof.

However, prior to obtaining the archive information (step 150), step 140 is first performed to determine if there exists the archive information of the data storage unit in the database. Only when the archive information of the data storage unit exists in the database, step 150 is performed to obtain the archive information from the database. When the archive information of the data storage unit does not exist in the database, step 170 is performed to wake up the data storage unit, and thereafter, step 180 is performed to obtain the archive information of the data storage unit from the data storage unit, and step 160 is performed to return the archive information of the data storage unit to the client side. After the archive information of the data storage unit is obtained from the data storage unit (step 180), step 190 is performed to record the archive information of the data storage unit in the database.

Further, when the data storage unit is not shut down, step 200 is performed to access the data storage unit directly according to the access instruction. In step 210, it is determined if the data storage unit has not been accessed for a period of time greater than a shut-off period of time. When the period of time is not greater than the shutoff period of time, step 210 is kept performing to continuously determine if the period of time during which the data storage unit are not accessed is greater than the shut-off period of time. However, when the period of time is greater than the shut-off period of time, step 230 is performed to shut down the data storage unit, and thus power consumption can be save by shutting down the data storage unit when a user has not accessed the data storage unit for a long time.

Before the data storage unit is shut down (step 230), its archive information can be first obtained so as to update the archive information of the data storage unit in the database (step 220). Thus, the use may thereafter browse the data storage unit which has been shut down by using the updated archive information stored in the database without needing to first waking up the data storage unit.

It can be known from the above embodiment that the application of the present invention has the following advantages. When a data storage unit desired to be browsed is shut down, the archive information of the data storage unit can be obtained from a databases so as to browse the data storage unit without needing to wake up the data storage unit which has been shut down. Consequently, the delay caused by waking up a data storage unit which has been shut down can be reduced, when the data storage unit is desired to be browsed. Further, since it does not need to wake up the data storage unit which has been shut down, the power consumption due to waking up the data storage unit which has been shut down can be saved. Besides, by decreasing the frequency of waking up the data storage unit, the probability of damaging the data storage unit can be lowered.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for accessing a data storage unit, comprising:
receiving an access instruction for the data storage unit from a client side;
determining if the access instruction is issued for browsing the data storage unit;
determining if the data storage unit has been shut down;
obtaining archive information of the data storage unit from a database, when the access instruction is issued for browsing the data storage unit which has been shut down; and
returning the archive information to the client side, so that the client side browses the data storage unit based on the archive information.

2. The method as claimed in claim 1, further comprising:
prior to the step of obtaining the archive information, determining if there exists the archive information of the data storage unit in the database.

3. The method as claimed in claim 2, further comprising:
when the archive information of the data storage unit does not exist in the databases waking up the data storage unit;
obtaining the archive information of the data storage unit from the data storage unit; and
recording the archive information of the data storage unit in the database.

4. The method as claimed in claim 1, further comprising:
when the data storage unit is not shut down, determining if data storage unit has not been accessed for a period of time greater than a shutoff period of time; and
when the period of time is greater than the shutoff period of time, shutting down the data storage unit.

5. The method as claimed in claim 1, further comprising:
updating the archive information of the data storage unit in the database.

6. The method as claimed in claim 1, further comprising:
when the access instruction is not issued for browsing the data storage unit, accessing the data storage unit in accordance with the access instruction.

7. The method as claimed in claim 1, wherein the database is stored in a memory device not belonging to the data storage unit.

8. The method as claimed in claim 1, wherein the memory device is a random access memory, a hard disk drive (HDD), a solid state disk (SDD), a flash disk or a hybrid hard disk.

9. The method as claimed in claim 1, wherein the data storage unit is a logic disk, a tangible hard disk or a remote storage unit.

10. The method as claimed in claim 1, wherein the tangible hard disk is a hard disk drives a solid state disk, a flash disk or a hybrid hard disk.
